(19) United States
(12) Patent Application Publication
(10) Pub. No.: US 2026/0230697 A1
(43) Pub. Date: Aug. 6, 2026

(54) CONTROL DEVICE, CONTROL METHOD, AND STORAGE MEDIUM

(71) Applicant: TOYOTA JIDOSHA KABUSHIKI KAISHA, Toyota-shi (JP)

(72) Inventor: Satoshi NAITO, Yokohama-shi (JP)

(73) Assignee: TOYOTA JIDOSHA KABUSHIKI KAISHA, Toyota-shi (JP)

(21) Appl. No.: 19/408,753

(22) Filed: Dec. 4, 2025

(30) Foreign Application Priority Data
Jan. 23, 2025 (JP) 2025-009839

(51) Int. Cl. H04N 23/61; B60R 11/04; G06V 20/56; G06V 20/59; H04N 23/20; H04N 23/56

(52) U.S. Cl. CPC H04N 23/61; B60R 11/04; G06V 20/588; G06V 20/597; H04N 23/20; H04N 23/56

(57) ABSTRACT

A control device controls a plurality of infrared camera modules for performing infrared imaging by irradiating an interior of a vehicle with an infrared ray, and is configured to select an infrared camera module for performing infrared imaging from among the infrared camera modules based on vehicle situation information indicating a situation of the vehicle.

### CROSS-REFERENCE TO RELATED APPLICATION

This application claims priority to Japanese Patent Application No. 2025-009839 filed on Jan. 23, 2025. The disclosure of the above-identified application, including the specification, drawings, and claims, is incorporated by reference herein in its entirety.

### BACKGROUND

### 1. Technical Field

The present disclosure relates to a control device, a control method, and a storage medium.

### 2. Description of Related Art

Japanese U.S. Pat. No. 6,743,708 (JP 6743708 B) discloses, as an imaging system in the related art, an imaging system that performs vehicle-to-vehicle communication between imaging control devices of vehicles including an infrared camera module for producing an infrared image to control infrared light irradiation timings of the infrared camera modules of the vehicles such that an image quality of an infrared image captured by an infrared camera module of one vehicle is not degraded by an influence of infrared light emitted from an infrared camera module of another vehicle.

### SUMMARY

However, JP 6743708 B does not disclose how to control each of the infrared camera modules such that one infrared camera module is not affected by an infrared ray emitted from another infrared camera module in a case where infrared imaging is performed on an interior of a vehicle by a plurality of the infrared camera modules.

The present disclosure has been made in view of such problems, and an object thereof is to enable appropriate use of each of infrared camera modules in a distinguished manner such that one infrared camera module is not affected by an infrared ray emitted from another infrared camera module in a case where infrared imaging is performed on an interior of a vehicle by a plurality of infrared camera modules.

In order to solve the above-described problem, a control device according to an aspect of the present disclosure controls a plurality of infrared camera modules for performing infrared imaging by irradiating an interior of a vehicle with an infrared ray. The control device is configured to select, based on vehicle situation information indicating a situation of the vehicle, an infrared camera module to be used for performing the infrared imaging from among the infrared camera modules to perform the infrared imaging.

In addition, a control method according to an aspect of the present disclosure is for controlling, using a control device, a plurality of infrared camera modules for performing infrared imaging by irradiating an interior of a vehicle with an infrared ray. The control method includes selecting, based on vehicle situation information indicating a situation of the vehicle, an infrared camera module to be used for performing the infrared imaging from among the infrared camera modules to perform the infrared imaging.

In addition, a non-transitory storage medium storing a computer program according to an aspect of the present disclosure causes a computer to execute a process including: controlling a plurality of infrared camera modules for performing infrared imaging by irradiating an interior of a vehicle with an infrared ray; and selecting, based on vehicle situation information indicating a situation of the vehicle, an infrared camera module to be used for performing the infrared imaging from among the infrared camera modules to perform the infrared imaging.

According to the aspects of the present disclosure, in a case where the infrared imaging is performed on the interior of the vehicle by the infrared camera modules, each of the infrared camera modules can be appropriately used in a distinguished manner depending on the situation of the vehicle, so that one infrared camera module can be prevented from being affected by an infrared ray emitted from another infrared camera module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an imaging system according to a first embodiment of the present disclosure;

FIG. 2 is a schematic system configuration diagram of the imaging system according to the first embodiment of the present disclosure;

FIG. 3 is a time chart showing an imaging timing of each of infrared camera modules of the imaging system according to the first embodiment of the present disclosure;

FIG. 4 is a flowchart for describing details of switching control of the infrared camera module according to the first embodiment of the present disclosure; and

FIG. 5 is a flowchart for describing details of switching control of the infrared camera module according to a second embodiment of the present disclosure.

### DETAILED DESCRIPTION OF EMBODIMENTS

Hereinafter, embodiments of the present disclosure will be described in detail with reference to the drawings. In the following description, the same reference numerals are given to the same constituent elements.

### First Embodiment

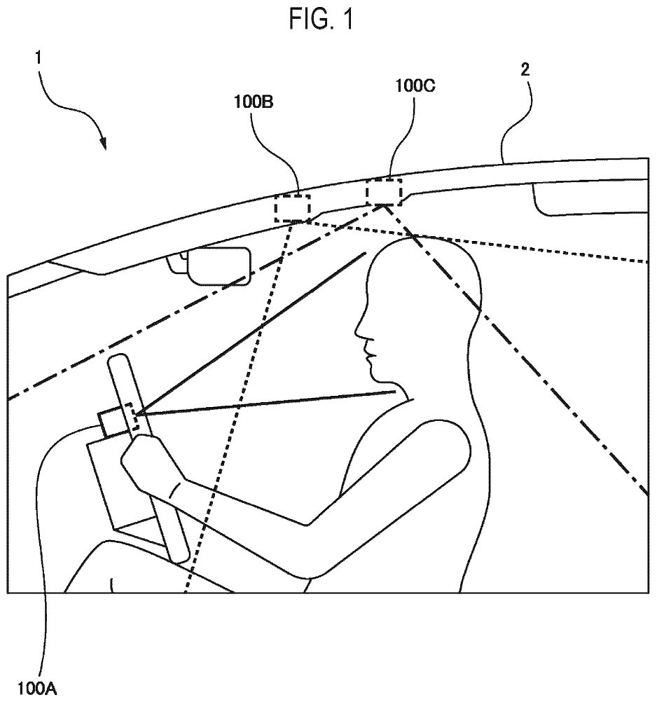

FIG. 1 is a schematic diagram of an imaging system 1 according to the first embodiment of the present disclosure.

The imaging system 1 is a system that performs imaging in a surveillance target range by a plurality of infrared camera modules in which at least a part of imaging ranges overlap.

As shown in FIG. 1, the imaging system 1 according to the present embodiment includes three infrared camera modules 100A, 100B, 100C, and is configured to perform imaging of an interior of a vehicle 2 (hereinafter, referred to as an “interior of the vehicle”).

The infrared camera module 100A is configured to image a face of a driver in the interior of the vehicle 2 as a main purpose of detecting a face orientation, a gaze direction, an eye open/close state, and the like of a driver of the vehicle 2, and is installed on an upper surface of a steering column in the present embodiment.

The infrared camera module 100B is configured to image each of seats in the interior of the vehicle 2 from above as a main purpose of detecting a state of attachment/detachment of a seat belt of a vehicle occupant seated on each of seats of the vehicle 2, and is installed on a ceiling in the interior of the vehicle in the present embodiment.

The infrared camera module 100C is configured to image a front seat in the interior of the vehicle 2 from above as a main purpose of detecting an operation of a hand of a vehicle occupant (a driver and a passenger on a passenger seat) seated on a front seat of the vehicle 2 (for example, an operation of a smartphone, an operation of a navigation device, and a finger-pointing operation), and is installed on a ceiling in the interior of the vehicle in the present embodiment.

In a case where imaging ranges of the infrared camera modules 100A to 100C are referred to as a first imaging range, a second imaging range, and a third imaging range, a face of the driver is basically included in any imaging range. That is, the first imaging range overlaps with at least a part of the second imaging range and the third imaging range, the second imaging range overlaps with at least a part of the first imaging range and the third imaging range, and the third imaging range overlaps with at least a part of the first imaging range and the second imaging range. Therefore, in a case where imaging timings of the infrared camera modules 100A to 100C are not appropriately controlled, a quality of an infrared image captured by another infrared camera module may be degraded (for example, halation or unnecessary shadow occurrence) due to an influence of infrared light emitted from one infrared camera module of the infrared camera modules 100A to 100C.

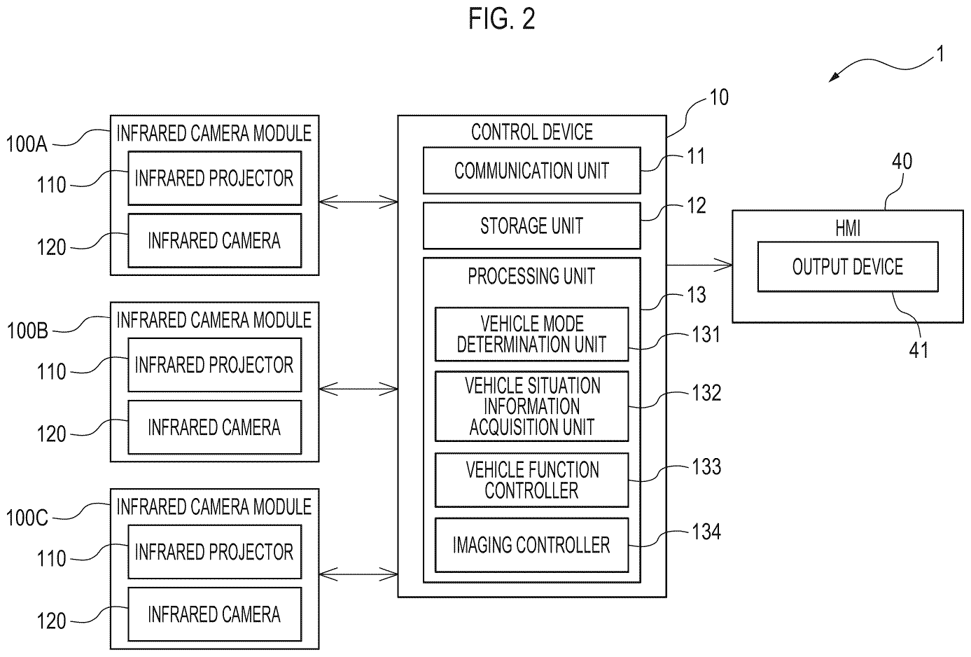

Therefore, in the present embodiment, the imaging timings of the infrared camera modules 100A to 100C can be appropriately controlled by switching the infrared camera module for performing infrared imaging according to the situation of the vehicle 2. Hereinafter, details of the switching control of the infrared camera module according to the present embodiment will be described with reference to FIGS. 2 to 4.

FIG. 2 is a schematic system configuration diagram of the imaging system 1.

The imaging system 1 includes a control device 10 that controls the infrared camera modules 100A to 100C, in addition to the infrared camera modules 100A to 100C.

The infrared camera modules 100A to 100C have the same configuration, and each include an infrared projector 110 and an infrared camera 120.

The infrared projector 110 includes an infrared ray emitting diode that emits infrared light, and irradiates a predetermined wavelength IR1 (nm) of infrared light toward an imaging range of the infrared camera 120 in response to an imaging instruction signal from the control device 10. IR1 (nm) is, for example, 850 nm or 940 nm.

The infrared camera 120 selectively receives the infrared light having the wavelength IR1 that is emitted from the infrared projector 110 and reflected from a subject, by using an optical filter or the like in response to the imaging instruction signal from the control device 10, and performs infrared imaging. The infrared camera 120 transmits an infrared image produced by the infrared imaging to the control device 10.

The control device 10 is an electronic control unit (ECU) including a communication unit 11, a storage unit 12, and a processing unit 13.

The communication unit 11 includes an interface circuit for connecting the control device 10 to the infrared camera modules 100A to 100C, a human machine interface (HMI) 40 described below, and the like. The communication unit 11 supplies, for example, data received from the outside, such as the infrared image received from the infrared camera modules 100A to 100C, to the processing unit 13. In addition, the communication unit 11 transmits, for example, an output signal output from the processing unit 13 to the outside, such as selectively transmitting the imaging instruction signal output from the processing unit 13 to the infrared camera modules 100A to 100C.

The storage unit 12 has a storage medium such as a hard disk drive (HDD), a solid state drive (SSD), and a semiconductor memory, and stores various computer programs, data, and the like used for processing in the processing unit 13.

The processing unit 13 has one or a plurality of central processing units (CPUs) and a peripheral circuit thereof, and executes various computer programs stored in the storage unit 12. The processing unit 13 is, for example, a processor. The processing unit 13 executes processing in accordance with a computer program to function as a vehicle mode determination unit 131, a vehicle situation information acquisition unit 132, a vehicle function controller 133, and an imaging controller 134, and operates as a functional unit (module) that realizes a predetermined function. In the following description, in a case where processing is described with each of functional units 131 to 134 as a subject, it is indicated that the processing unit 13 executes a program that realizes each of functional units 131 to 134.

The vehicle mode determination unit 131 determines a mode of a power switch of the vehicle 2. In the present embodiment, there are three types of modes of the power switch of the vehicle, that is, an OFF mode, an accessory (ACC) mode, and an ON mode. The OFF mode is a mode in which a function of the vehicle 2 is stopped to stop the vehicle 2. The ACC mode is a mode in which the vehicle 2 does not travel, and in which a power supply is supplied to some electrical equipment, but the vehicle 2 itself cannot travel. The ON mode is a mode in which a power supply is supplied to all electrical equipment to enable the vehicle 2 to travel.

In the present embodiment, in a case where the mode of the power switch of the vehicle 2 is switched from the OFF mode or the ACC mode to the ON mode, the infrared imaging by the infrared camera modules 100A to 100C of the imaging system 1 is started according to the situation of the vehicle 2. In a case where the mode of the power switch of the vehicle 2 is switched from the ON mode to the ACC mode or the OFF mode, the infrared imaging by the infrared camera modules 100A to 100C is stopped.

The vehicle situation information acquisition unit 132 acquires information indicating whether the vehicle 2 is traveling or not moving, as vehicle situation information indicating the situation of the vehicle 2. The information indicating whether the vehicle 2 is traveling or not moving can be, for example, vehicle speed information of the vehicle 2 obtained by a vehicle speed sensor or the like. In addition to or instead of the information indicating whether the vehicle 2 is traveling or not moving, information indicating whether a road situation around the vehicle 2 is in a traffic jam may be acquired. The information indicating whether the road situation around the vehicle 2 is in a traffic jam can be, for example, road information obtained by receiving the information from an external information center or the like, or road information around the vehicle 2 obtained by analyzing a surrounding image captured around the vehicle 2.

The vehicle function controller 133 receives an infrared image (hereinafter, referred to as a “first infrared image”) produced by the infrared camera 120 of the infrared camera module 100A, that is, the first infrared image in which the face of the driver is imaged, and controls a function of the vehicle 2 based on the received first infrared image.

In the present embodiment, the vehicle function controller 133 detects the driver's side glance or drowsiness by analyzing the first infrared image in which the face of the driver is imaged to detect the face orientation, the gaze direction, the eye open/close state, and the like of the driver, and controls the HMI 40 of the vehicle 2 according to a detection result. The HMI 40 is a user interface for exchanging information between the vehicle 2 and the vehicle occupant, and includes at least an output device 41 for notifying the vehicle occupant through a sensory perception (for example, visual, auditory, and tactile perceptions) of the vehicle occupant. The output device 41 is, for example, a display (for example, a meter display, a center display, or a head-up display), a speaker, a vibration body, or the like. For example, in the present embodiment, in a case where the side glance or drowsiness of the driver is detected, the vehicle function controller 133 issues a warning to the vehicle occupant via the output device 41 of the HMI 40.

In addition, the vehicle function controller 133 receives an infrared image (hereinafter, referred to as a “second infrared image”) produced by the infrared camera 120 of the infrared camera module 100B, that is, the second infrared image in which the vehicle occupant seated on each of seats of the vehicle 2 is imaged from above, and controls a function of the vehicle 2 based on the received second infrared image.

In the present embodiment, the vehicle function controller 133 estimates an emotion of the vehicle occupant by analyzing the second infrared image in which the vehicle occupant seated on each of seats of the vehicle 2 is imaged from above to detect an expression of the vehicle occupant, and controls the HMI 40 of the vehicle 2 according to the estimation result. For example, in the present embodiment, the vehicle function controller 133 proposes music playback according to the emotion of the vehicle occupant to the vehicle occupant via the output device 41 of the HMI 40.

Further, the vehicle function controller 133 receives an infrared image (hereinafter, referred to as a “third infrared image”) produced by the infrared camera 120 of the infrared camera module 100C, that is, the third infrared image in which the vehicle occupant seated on a front seat (driver's seat and passenger seat) of the vehicle 2 is imaged from above, and controls a function of the vehicle 2 based on the received third infrared image.

In the present embodiment, the vehicle function controller 133 detects an operation of the hand of the vehicle occupant seated on the front seat by analyzing the third infrared image in which the vehicle occupant seated on the front seat of the vehicle 2 is imaged from above, and controls the HMI 40 of the vehicle 2 according to the detection result. For example, in the present embodiment, the vehicle function controller 133 detects a store or the like present in a finger-pointing direction of the vehicle occupant from the operation of the hand of the vehicle occupant, and notifies the vehicle occupant of information on the store or the like via the output device 41 of the HMI 40.

As described above, the infrared images produced by the infrared cameras 120 of the infrared camera modules 100A to 100C are used for different purposes, and in the present embodiment, the purpose of use of the first infrared image can be said to be a purpose related to safety of the vehicle occupant while the vehicle is traveling (hereinafter, referred to as a “safety purpose”), and the purpose of use of the second infrared image and the third infrared image can be said to be a purpose related to convenience of the vehicle occupant during vehicle riding (hereinafter, referred to as a “convenience purpose”) and a purpose different from the safety purpose.

In the present embodiment, the warning to the vehicle occupant via the output device 41 of the HMI 40 is issued as the driving assistance related to the safety of the vehicle occupant while the vehicle is traveling, using the infrared image (the first infrared image in the present embodiment) used for the safety purpose. Therefore, in a case where the image of the infrared image (the first infrared image in the present embodiment) used for the safety purpose is degraded due to the influence of the infrared ray emitted from the infrared camera module that acquires the infrared image (the second infrared image and the third infrared image in the present embodiment) used for the convenience purpose while the vehicle is traveling, there is a concern that the driving assistance related to the safety of the vehicle occupant while the vehicle is traveling may be adversely affected.

Therefore, in the present embodiment, while the vehicle is traveling, the infrared camera module that produces the infrared image used for the safety purpose is selected from among the infrared camera modules 100A to 100C as the infrared camera module that performs the infrared imaging, and the infrared imaging is performed by the selected infrared camera module. In addition, while the vehicle is not moving, the infrared camera module that produces the infrared image used for the convenience purpose is selected from among the infrared camera modules 100A to 100C as the infrared camera module that performs the infrared imaging, and the infrared imaging is performed by the selected infrared camera module.

As a result, it is possible to reduce degradation of the image of the infrared image used for the safety purpose due to the influence of the infrared ray emitted from the infrared camera module that produces the infrared image used for the convenience purpose while the vehicle is traveling. Therefore, it is possible to prevent the driving assistance related to the safety of the vehicle occupant while the vehicle is traveling from being adversely affected by the degradation in the infrared image used for the safety purpose.

In a case where a plurality of infrared camera modules that produce the infrared image used for the safety purpose are present, for example, by using the infrared camera modules in order while the vehicle is traveling, it is possible to prevent the one infrared camera module that produces the infrared image used for the safety purpose from being affected by the influence of the infrared ray emitted from the other infrared camera module that produces the infrared image used for the safety purpose. Similarly, in a case where a plurality of infrared camera modules that produce the infrared image used for the convenience purpose are present, it is possible to prevent the one infrared camera module that produces the infrared image used for the convenience purpose from being affected by the influence of the infrared ray emitted from the other infrared camera module that produces the infrared image used for the convenience purpose by using the infrared camera modules in order while the vehicle is not moving.

The imaging controller 134 controls the infrared camera modules 100A to 100C. The imaging controller 134 selects the infrared camera module that performs infrared imaging from among the infrared camera modules 100A to 100C based on the vehicle situation information indicating the status of the vehicle 2, so that the quality of the infrared image captured by the other infrared camera module is not degraded (for example, halation or unnecessary shading does not occur) due to the influence of the infrared light emitted from one infrared camera module among the infrared camera modules 100A to 100C, and transmits the imaging instruction signal to the selected infrared camera module.

In the present embodiment, as described above, the imaging controller 134 selects the infrared camera module 100A that produces the infrared image used for the safety purpose from among the infrared camera modules 100A to 100C as the infrared camera module that performs the infrared imaging while the vehicle is traveling, and transmits the imaging instruction signal to the infrared camera module 100A. In addition, while the vehicle is not moving, the infrared camera modules 100B, 100C that produce the infrared image used for the convenience purpose are selected from among the infrared camera modules 100A to 100C as the infrared camera module that performs the infrared imaging, and the imaging instruction signal is transmitted to the infrared camera modules 100B, 100C.

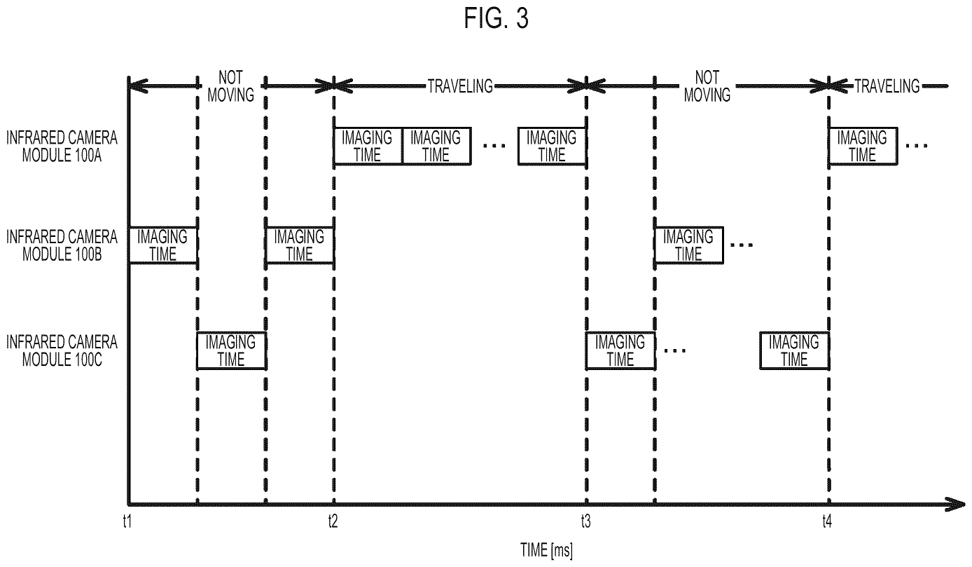

FIG. 3 is a time chart showing an imaging timing of the infrared camera modules 100A to 100C.

In a case where the mode of the power switch of the vehicle 2 is switched to the ON mode at time t1, the infrared camera module that performs the infrared imaging is selected from among the infrared camera modules 100A to 100C based on the vehicle situation information, and the imaging instruction signal is transmitted from the control device 10 to the selected infrared camera module.

In the example shown in FIG. 3, since the vehicle 2 is not moving during a period from time t1 to time t2, the control device 10 selects the infrared camera modules 100B, 100C that produce the infrared image used for the convenience purpose as the infrared camera module that performs the infrared imaging, and alternately transmits the imaging instruction signal to the infrared camera modules 100B, 100C. Specifically, in a case where a time during which the infrared light is emitted by the infrared projector and the exposure is performed by the infrared camera is referred to as an “imaging time (one-time imaging time)” of the infrared imaging by the infrared camera module, the control device 10 alternately transmits the imaging instruction signal to the infrared camera modules 100B, 100C such that the imaging times of the infrared camera modules 100B, 100C do not overlap. In a case where the imaging instruction signal is received from the control device 10, the infrared camera modules 100B, 100C start the emission of the infrared light by the infrared projector 110 and the exposure by the infrared camera 120, and perform the infrared imaging.

In a case where determination is made at time t2 that the vehicle 2 is traveling based on the vehicle situation information, the control device 10 selects the infrared camera module 100A that produces the infrared image used for the safety purpose as the infrared camera module that performs the infrared imaging, and transmits the imaging instruction signal to the infrared camera module 100A at a predetermined imaging cycle until time t3 at which determination is made that the vehicle 2 is not moving.

In a case where determination is made at time t3 that the vehicle 2 is not moving based on the vehicle situation information, the control device 10 selects the infrared camera modules 100B, 100C that produce the infrared image used for the convenience purpose as the infrared camera module that performs the infrared imaging, and alternately transmits the imaging instruction signal to the infrared camera modules 100B, 100C as in the period from time t1 to time t2. In a case where determination is made at time t4 that the vehicle 2 is traveling based on the vehicle situation information, the control device 10 selects the infrared camera module 100A that produces the infrared image used for the safety purpose as the infrared camera module that performs the infrared imaging, and transmits the imaging instruction signal to the infrared camera module 100A at a predetermined imaging cycle until determination is made that the vehicle 2 is not moving.

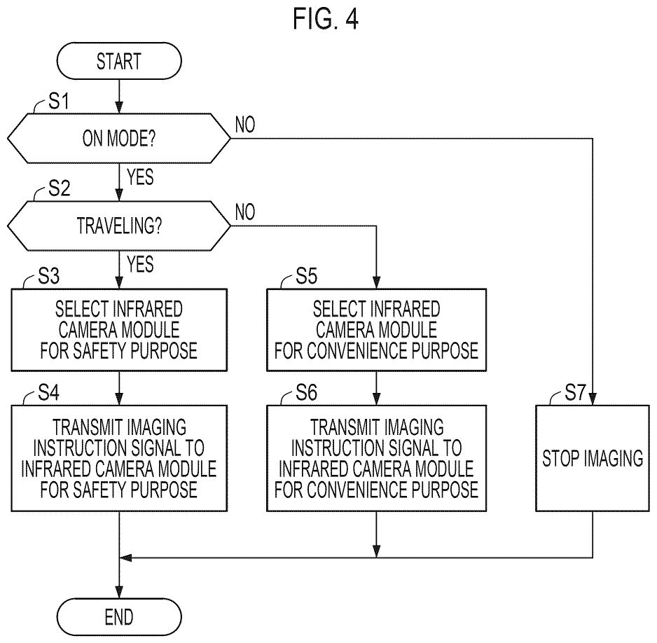

FIG. 4 is a flowchart for describing details of the switching control of the infrared camera module according to the present embodiment that is performed by the control device 10.

In S1, the control device 10 determines whether the mode of the power switch of the vehicle 2 is the ON mode. In a case where the mode of the power switch of the vehicle 2 is the ON mode, the control device 10 proceeds to the processing of S2. On the other hand, in a case where the mode of the power switch of the vehicle 2 is not the ON mode, the control device 10 proceeds to the processing of S7.

In S2, the control device 10 determines whether the vehicle 2 is traveling based on the vehicle situation information. In a case where the vehicle 2 is traveling, the control device 10 proceeds to the processing of S3. On the other hand, in a case where the vehicle 2 is not traveling, the control device 10 proceeds to the processing of S5.

In a case where the information indicating whether the road situation around the vehicle 2 is in a traffic jam is acquired in addition to the information indicating whether the vehicle 2 is traveling or not moving, as the vehicle situation information, for example, the processing of S3 can be performed in a case where the vehicle 2 is traveling and not in a traffic jam, and the processing of S5 can be performed in a case where the vehicle 2 is not moving or in a traffic jam. In addition, in a case where the information indicating whether the road situation around the vehicle 2 is in a traffic jam is acquired instead of the information indicating whether the vehicle 2 is traveling or not moving, as the vehicle situation information, for example, the processing of S3 can be performed in a case where the vehicle 2 is not in a traffic jam, and the processing of S5 can be performed in a case where the vehicle 2 is in a traffic jam.

In S3, the control device 10 selects the infrared camera module that produces the infrared image used for the safety purpose from among the infrared camera modules as the infrared camera module that performs the infrared imaging. Therefore, in the present embodiment, the control device 10 selects the infrared camera module 100A as the infrared camera module that performs the infrared imaging.

In S4, the control device 10 transmits the imaging instruction signal to the infrared camera module that produces the infrared image used for the safety purpose. For example, in a case where only one infrared camera module that produces the infrared image used for the safety purpose is present, the control device 10 transmits the imaging instruction signal to the one infrared camera module at a predetermined imaging cycle. On the other hand, in a case where a plurality of infrared camera modules that produce the infrared image used for the safety purpose are present, the imaging instruction signal is transmitted to each of infrared camera modules in order such that the imaging times of the infrared camera modules do not overlap.

Therefore, in the present embodiment, since only one infrared camera module 100A produces the infrared image used for the safety purpose, the control device 10 transmits the imaging instruction signal to the infrared camera module 100A at a predetermined imaging cycle.

In S5, the control device 10 selects the infrared camera module that produces the infrared image used for the convenience purpose from among the infrared camera modules as the infrared camera module that performs the infrared imaging. Therefore, in the present embodiment, the control device 10 selects the infrared camera modules 100B, 100C as the infrared camera module that performs the infrared imaging.

In S6, the control device 10 transmits the imaging instruction signal to the infrared camera module that produces the infrared image used for the convenience purpose. For example, in a case where only one infrared camera module that produces the infrared image used for the convenience purpose is present, the control device 10 transmits the imaging instruction signal to the one infrared camera module at a predetermined imaging cycle. On the other hand, in a case where a plurality of infrared camera modules that produce the infrared image used for the convenience purpose are present, the imaging instruction signal is transmitted to each of infrared camera modules in order such that the imaging times of the infrared camera modules do not overlap.

Therefore, in the present embodiment, since two infrared camera modules 100B, 100C produce the infrared image used for the convenience purpose, the control device 10 transmits the imaging instruction signal to the infrared camera modules 100B, 100C in order such that the imaging times of the infrared camera modules 100B, 100C do not overlap.

In S7, the control device 10 stops the infrared imaging by the infrared camera modules 100A to 100C.

The control device 10 that controls the infrared camera modules 100A to 100C for performing the infrared imaging by irradiating the interior of the vehicle 2 with the infrared ray according to the present embodiment is configured to select the infrared camera module that performs the infrared imaging from among the infrared camera modules 100A to 100C based on the vehicle situation information (for example, information indicating whether the vehicle 2 is traveling or not moving, and information indicating the road situation around the vehicle 2) indicating the situation of the vehicle 2.

As a result, since the infrared camera modules 100A to 100C for performing the infrared imaging can be appropriately used according to the situation of the vehicle 2, it is possible to reduce a situation in which the quality of the infrared image captured by the other infrared camera module is degraded due to the influence of the infrared ray emitted from one infrared camera module.

More specifically, the control device 10 according to the present embodiment is configured to select the infrared camera module 100A that produces the infrared image used for the safety driving assistance of the vehicle 2 from among the infrared camera modules 100A to 100C in a case where the vehicle 2 is traveling or the road situation around the vehicle 2 is in a traffic jam, and select the infrared camera modules 100B, 100C that produce the infrared image used for a purpose different from the safety driving assistance of the vehicle 2 from among the infrared camera modules 100A to 100C in a case where the vehicle 2 is not moving or the road situation around the vehicle 2 is not in a traffic jam.

As a result, in a case where the vehicle 2 is not traveling or not in a traffic jam, the infrared camera module 100A that produces the infrared image used for the safety driving assistance of the vehicle is selected as the infrared camera module that performs the infrared imaging, and the infrared imaging by the other infrared camera modules 100B, 100C is basically not performed, so that it is possible to reduce the degradation in the quality of the infrared image used for the safety driving assistance of the vehicle 2. As a result, the safety driving assistance of the vehicle 2 can be precisely performed.

### Second Embodiment

Next, a second embodiment of the disclosure will be described. The present embodiment is different from the first embodiment in that, in a case where infrared imaging by an infrared camera module that produces an infrared image used for a convenience purpose is continued for a predetermined period of time, the infrared imaging by an infrared camera module that produces an infrared image used for a safety purpose is performed one or more times, and then the infrared imaging by the infrared camera module that produces the infrared image used for the convenience purpose is resumed, and similarly, in a case where the infrared imaging by the infrared camera module that produces the infrared image used for the safety purpose is continued for the predetermined period of time, the infrared imaging by the infrared camera module that produces the infrared image used for the convenience purpose is performed one or more times, and then the infrared imaging by the infrared camera module that produces the infrared image used for the safety purpose is resumed. The difference will be mainly described below.

In a case of the first embodiment described above, for example, in a case where the situation in which the vehicle 2 is not moving is long, a period in which the infrared imaging by the infrared camera module that produces the infrared image used for the safety purpose is not performed is also long. Therefore, in some cases, it is desirable to perform the infrared imaging by the infrared camera module that produces the infrared image used for the safety purpose once or more during the stop even in a case where the vehicle 2 is not moving. Similarly, in a case where the situation in which the vehicle 2 is traveling is long, a period in which the infrared imaging by the infrared camera module that produces the infrared image used for the convenience purpose is not performed is also long, so that it is desirable to perform the infrared imaging by the infrared camera module that produces the infrared image used for the convenience purpose once or more during the traveling in some cases.

Therefore, in the present embodiment, in a case where infrared imaging by an infrared camera module that produces an infrared image used for a convenience purpose is continued for a predetermined period of time, the infrared imaging by an infrared camera module that produces an infrared image used for a safety purpose is performed one or more times, and then the infrared imaging by the infrared camera module that produces the infrared image used for the convenience purpose is resumed. Similarly, in a case where the infrared imaging by the infrared camera module that produces the infrared image used for the safety purpose is continued for a predetermined period of time, the infrared imaging by the infrared camera module that produces the infrared image used for the convenience purpose is performed one or more times, and then the infrared imaging by the infrared camera module that produces the infrared image used for the safety purpose is resumed.

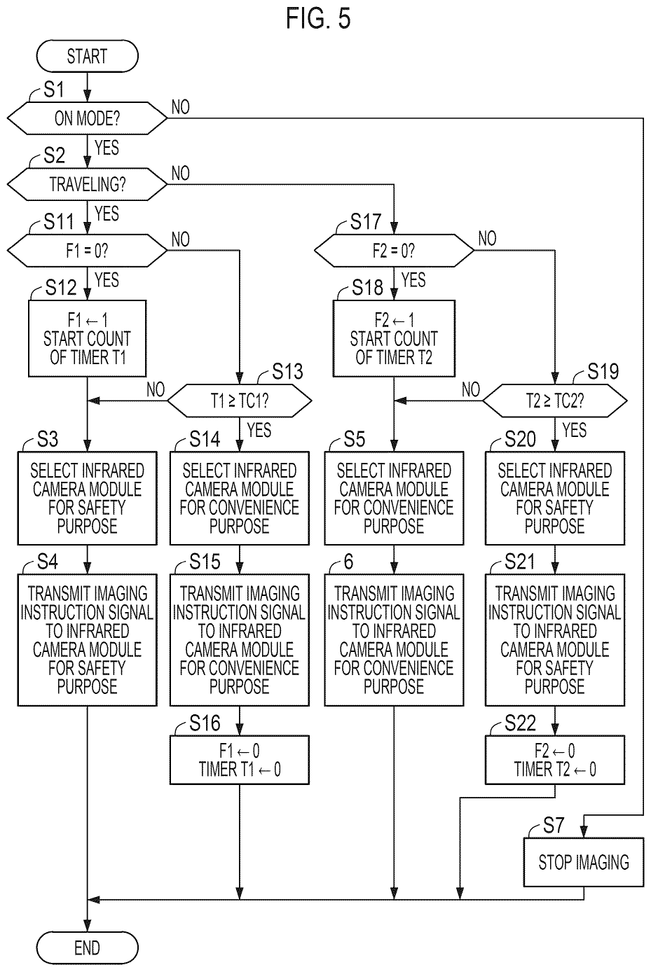

FIG. 5 is a flowchart for describing the switching control of the infrared camera module according to the present embodiment. In FIG. 5, contents of the processing of S1 to S7 are the same as those of the first embodiment, so that the description thereof will be omitted here.

In S11, the control device 10 determines whether the traveling flag F1 is set to 0. The traveling flag F1 is a flag that is set from 0 to 1 in a case where determination is made that the vehicle 2 is traveling, and the initial value thereof is 0. In a case where the traveling flag F1 is set to 0, the control device 10 proceeds to the processing of S12. On the other hand, in a case where the traveling flag F1 is set to 1, the control device 10 proceeds to the processing of S13.

In S12, the control device 10 sets the traveling flag F1 to 1 and starts the count of the timer T1. The timer T1 is a timer for detecting a time from when the traveling flag F1 is switched from 0 to 1, that is, a time from when the infrared imaging by the infrared camera module that produces the infrared image used for the safety purpose is started.

In S13, the control device 10 determines whether the timer T1 is equal to or longer than a predetermined first switching time TC1. In a case where the timer T1 is equal to or longer than the first switching time TC1, the control device 10 proceeds to the processing of S14 to temporarily switch the infrared camera module that performs the infrared imaging from the one for the safety purpose to the one for the convenience purpose. On the other hand, in a case where the timer T1 is shorter than the first switching time TC1, the control device 10 proceeds to the processing of S3.

In S14, the control device 10 temporarily selects the infrared camera module that produces the infrared image used for the convenience purpose as the infrared camera module that performs the infrared imaging. Therefore, in the present embodiment, the control device 10 selects the infrared camera modules 100B, 100C as the infrared camera module that performs the infrared imaging.

In S15, the control device 10 transmits the imaging instruction signal to the infrared camera module that produces the infrared image used for the convenience purpose only once. For example, in a case where only one infrared camera module that produces the infrared image used for the convenience purpose is present, the control device 10 transmits the imaging instruction signal to the one infrared camera module. On the other hand, in a case where a plurality of infrared camera modules that produce the infrared image used for the convenience purpose are present, the imaging instruction signal is transmitted to each of infrared camera modules only once in order such that the imaging times of the infrared camera modules do not overlap.

In the present embodiment, as described above, the infrared imaging by the infrared camera module that produces the infrared image used for the convenience purpose is performed only once, and then the infrared imaging by the infrared camera module that produces the infrared image used for the safety purpose is resumed. However, the present disclosure is not limited thereto. For example, the infrared imaging by the infrared camera module that produces the infrared image used for the safety purpose may be resumed after the infrared imaging by the infrared camera module that produces the infrared image used for the convenience purpose is performed a predetermined number of times.

In S16, the control device 10 sets the traveling flag F1 to 0 and resets the timer T1.

In S17, the control device 10 determines whether the stop flag F2 is set to 0. The stop flag F2 is a flag that is set from 0 to 1 in a case where determination is made that the vehicle 2 is not traveling, that is, is not moving, and the initial value thereof is 0. In a case where the stop flag F2 is set to 0, the control device 10 proceeds to the processing of S18. On the other hand, in a case where the stop flag F2 is set to 1, the control device 10 proceeds to the processing of S1*.

In S18, the control device 10 sets the stop flag F2 to 1 and starts the count of the timer T2. The timer T2 is a timer for detecting a time from when the stop flag F2 is switched from 0 to 1, that is, a time from when the infrared imaging by the infrared camera module that produces the infrared image used for the convenience purpose is started.

In S19, the control device 10 determines whether the timer T2 is equal to or longer than a predetermined second switching time TC2. In a case where the timer T2 is equal to or longer than the second switching time TC2, the control device 10 proceeds to the processing of S20 to temporarily switch the infrared camera module that performs the infrared imaging from the one for the convenience purpose to the one for the safety purpose. On the other hand, in a case where the timer T2 is shorter than the second switching time TC2, the control device 10 proceeds to the processing of S5.

In S20, the control device 10 temporarily selects the infrared camera module that produces the infrared image used for the safety purpose as the infrared camera module that performs the infrared imaging. Therefore, in the present embodiment, the control device 10 selects the infrared camera module 100A as the infrared camera module that performs the infrared imaging.

In S21, the control device 10 transmits the imaging instruction signal to the infrared camera module that produces the infrared image used for the safety purpose only once. For example, in a case where only one infrared camera module that produces the infrared image used for the safety purpose is present, the control device 10 transmits the imaging instruction signal to the one infrared camera module. On the other hand, in a case where a plurality of infrared camera modules that produce the infrared image used for the safety purpose are present, the imaging instruction signal is transmitted to each of infrared camera modules only once in order such that the imaging times of the infrared camera modules do not overlap.

In the present embodiment, as described above, the infrared imaging by the infrared camera module that produces the infrared image used for the safety purpose is performed only once, and then the infrared imaging by the infrared camera module that produces the infrared image used for the convenience purpose is resumed. However, the present disclosure is not limited thereto. For example, the infrared imaging by the infrared camera module that produces the infrared image used for the convenience purpose may be resumed after the infrared imaging by the infrared camera module that produces the infrared image used for the safety purpose is performed a predetermined number of times.

In S22, the control device 10 sets the stop flag F2 to 0 and resets the timer T2.

The control device 10 according to the present embodiment is configured to, in a case where the infrared imaging by the infrared camera module (selected camera module) selected based on the vehicle situation information is continued for a predetermined period of time, perform the infrared imaging by another infrared camera module (non-selected camera module) different from the infrared camera module (selected camera module) selected based on the vehicle situation information one or more times, and then resume the infrared imaging by the infrared camera module (selected camera module) selected based on the vehicle situation information.

As a result, it is possible to prevent the infrared imaging by another infrared camera module (non-selected camera module) different from the infrared camera module (selected camera module) selected based on the vehicle situation information from being performed for a long period of time, and to adjust the imaging frequency of each of the infrared camera modules 100A to 100C.

Although the embodiments of the disclosure have been described above, the above embodiments merely show a part of application examples of the disclosure, and are not intended to limit the technical scope of the disclosure to the specific configurations of the embodiments.

For example, in each of the above-described embodiments, the example in which three infrared camera modules are used is shown and described. However, of course, the number of infrared camera modules may be two or four or more.

In addition, in the above-described embodiment, the infrared camera module 100B is used as the infrared camera module that produces the infrared image for the convenience purpose. However, the infrared camera module 100B may be used as the infrared camera module that produces the infrared image for the safety purpose. Specifically, the seat belt attachment/detachment state of the vehicle occupant may be detected by analyzing the second infrared image, and the HMI 40 of the vehicle 2 may be controlled according to the detection result, so that, for example, in a case where the vehicle function controller 133 detects the presence of the vehicle occupant who does not wear the seat belt, the warning to the vehicle occupant may be issued via the output device 41 of the HMI 40.

In addition, in the above-described embodiment, the computer program executed in the control device 10 may be provided in a form of being recorded in a computer-readable portable recording medium such as a semiconductor memory, a magnetic recording medium, or an optical recording medium, or may be provided as a computer program product.

What is claimed is:

1. A control device that controls a plurality of infrared camera modules for performing infrared imaging by irradiating an interior of a vehicle with an infrared ray, wherein the control device is configured to select, based on vehicle situation information indicating a situation of the vehicle, an infrared camera module to be used for performing the infrared imaging from among the infrared camera modules to perform the infrared imaging.

2. The control device according to claim 1, wherein:
while the vehicle is traveling or when a road situation around the vehicle is in a traffic jam, an infrared camera module that produces an infrared image that is used for performing safety driving assistance for the vehicle is selected from among the infrared camera modules; and
while the vehicle is not moving or when the road situation around the vehicle is not in a traffic jam, an infrared camera module that produces an infrared image that is used for a purpose other than the safety driving assistance for the vehicle is selected from among the infrared camera modules.

3. The control device according to claim 1, wherein, when infrared imaging using a selected camera module selected based on the vehicle situation information is continued for a predetermined period of time, the infrared imaging using the selected camera module is resumed after infrared imaging using a non-selected camera module other than the selected camera module is performed one or more times.

4. A control method for controlling, using a control device, a plurality of infrared camera modules for performing infrared imaging by irradiating an interior of a vehicle with an infrared ray, the control method comprising selecting, based on vehicle situation information indicating a situation of the vehicle, an infrared camera module to be used for performing the infrared imaging from among the infrared camera modules to perform the infrared imaging.

5. A non-transitory storage medium storing a computer program for causing a computer to execute a process comprising:
controlling a plurality of infrared camera modules for performing infrared imaging by irradiating an interior of a vehicle with an infrared ray; and
selecting, based on vehicle situation information indicating a situation of the vehicle, an infrared camera module to be used for performing the infrared imaging from among the infrared camera modules to perform the infrared imaging.
